(19) United States
(12) Patent Application Publication
(10) Pub. No.: US 2019/0154183 A1
(43) Pub. Date: May 23, 2019

(54) Pipe Enclosure

(71) Applicant: Integrated Process Resources, Inc., dba Think Environmental, Houston, TX (US)

(72) Inventors: William Joseph Speakman, Sicklerville, NJ (US); Richard Taylor Pruet, Friendswood, TX (US); Robert Lloyd Cortiaus, Friendswood, TX (US)

(21) Appl. No.: 16/195,141

(22) Filed: Nov. 19, 2018

Related U.S. Application Data
(60) Provisional application No. 62/589,370, filed on Nov. 21, 2017.

(51) Int. Cl. F16L 55/172; F16L 55/175

(52) U.S. Cl. CPC F16L 55/172; F16L 55/175

(57) ABSTRACT

In an embodiment, a pipe enclosure includes: a body having a void; a male interlocking portion at a first end of the body, the male interlocking portion and the body being integrally formed of a metal, the male interlocking portion having a first bore extending therethrough, the first bore being contiguous with the void; and a female interlocking portion at a second end of the body, the female interlocking portion and the body being integrally formed of the metal, the female interlocking portion having a second bore extending therethrough, the second bore being contiguous with the void, the female interlocking portion and the male interlocking portion having complimentary shapes.

### CROSS-REFERENCE TO RELATED APPLICATIONS

This application claims the benefit of U.S. Provisional Application No. 62/589,370, filed on Nov. 21, 2017, which application is hereby incorporated herein by reference.

### BACKGROUND

Leaks may develop in a pipe, resulting in loss of products carried in the pipe. Further, products carried in the pipe may be discharge into the environment through the leaks. Repairing pipe leaks may avoid product losses and may be required by law. However, stopping the flow of products in the pipe may be costly. Repairing leaks while the pipe remains online, e.g., while product continues flowing in the pipe, may avoid work stops and lost revenue for the operator.

### SUMMARY

In an embodiment, a pipe enclosure includes: a body having a void; a male interlocking portion at a first end of the body, the male interlocking portion and the body being integrally formed of a metal, the male interlocking portion having a first bore extending therethrough, the first bore being contiguous with the void; a female interlocking portion at a second end of the body, the female interlocking portion and the body being integrally formed of the metal, the female interlocking portion having a second bore extending therethrough, the second bore being contiguous with the void, the female interlocking portion and the male interlocking portion having complimentary shapes; a first bore groove in the body, the first bore groove being disposed around the first bore; a second bore groove in the body, the second bore groove being disposed around the second bore; and a periphery groove in the body, the periphery groove being disposed around the periphery of the void, the periphery groove being contiguous with the first bore groove and the second bore groove.

In some embodiments, the pipe enclosure further includes: an injection valve extending through the body, the injection valve being contiguous with the void. In some embodiments, the pipe enclosure further includes: an injection valve extending through the body, the injection valve being contiguous with the first bore. In some embodiments, the pipe enclosure further includes: a first injection valve extending through the body, the first injection valve being contiguous with the first bore groove; a second injection valve extending through the body, the second injection valve being contiguous with the second bore groove; and a third injection valve extending through the body, the third injection valve being contiguous with the periphery groove. In some embodiments of the pipe enclosure, the body includes: a first half having a first clamping hole extending therethrough; and a second half having a second clamping hole extending therethrough, where the first clamping hole and the second clamping hole are aligned when the first half is mated to the second half. In some embodiments of the pipe enclosure, the first bore groove is formed in the first half and the second half of the body, and the second bore groove is formed in the first half and the second half of the body. In some embodiments of the pipe enclosure, the periphery groove is formed in mating surfaces of the first half of the body, and the periphery groove mates to corresponding mating surfaces of the second half of the body. In some embodiments of the pipe enclosure, the male interlocking portion includes: a neck extending from the first end of the body, the neck having a first diameter; and a lip connected to the neck, the lip having a second diameter, the second diameter being greater than the first diameter. In some embodiments of the pipe enclosure, the female interlocking portion includes: a lip groove in a second end of the body, the lip groove having the second diameter; and a neck groove being contiguous with the lip groove, the neck groove having the first diameter. In some embodiments of the pipe enclosure, the neck is disposed between the lip and the first bore groove, and the lip groove is disposed between the neck groove and the second bore groove.

In an embodiment, a system includes: a pipe; a first pipe enclosure around the pipe, the first pipe enclosure including: a first body having a first void surrounding the pipe; a first male interlocking portion at a first end of the first body, the first male interlocking portion and the first body being integrally formed of a first metal, the first male interlocking portion having a first bore extending therethrough, the first bore being contiguous with the first void; and a first female interlocking portion at a second end of the first body, the first female interlocking portion and the first body being integrally formed of the first metal, the first female interlocking portion having a second bore extending therethrough, the second bore being contiguous with the first void, the first female interlocking portion and the first male interlocking portion having complimentary shapes; and a second pipe enclosure around the pipe, the second pipe enclosure including: a second body having a second void surrounding the pipe; a second male interlocking portion at a first end of the second body, the second male interlocking portion and the second body being integrally formed of a second metal, the second male interlocking portion having a third bore extending therethrough, the third bore being contiguous with the second void; and a second female interlocking portion at a second end of the second body, the second female interlocking portion and the second body being integrally formed of the second metal, the second female interlocking portion having a fourth bore extending therethrough, the fourth bore being contiguous with the second void, the second female interlocking portion and the second male interlocking portion having complimentary shapes, where the first male interlocking portion of the first pipe enclosure is connected to the second female interlocking portion of the second pipe enclosure.

In some embodiments of the system, the first void and the second void are filled with a sealant. In some embodiments of the system, the first male interlocking portion includes: a neck extending from the first end of the first body, the neck having a first diameter; and a lip connected to the neck, the lip having a second diameter, the second diameter being greater than the first diameter. In some embodiments of the system, the second female interlocking portion includes: a lip groove in second end of the second body, the lip groove having the second diameter; and a neck groove being contiguous with the lip groove, the neck groove having the first diameter.

In an embodiment, a method includes: identifying a first leak along a pipe; attaching a first pipe enclosure to the pipe, the first pipe enclosure including: a first body having a first void; a first male interlocking portion at a first end of the first body, the first male interlocking portion and the first body being integrally formed of a first metal, the first male interlocking portion having a first bore extending therethrough, the first bore being contiguous with the first void; and a first female interlocking portion at a second end of the first body, the first female interlocking portion and the first body being integrally formed of the first metal, the first female interlocking portion having a second bore extending therethrough, the second bore being contiguous with the first void, the first female interlocking portion and the first male interlocking portion having complimentary shapes; and injecting a first sealant into the first void of the first pipe enclosure.

In some embodiments, the method further includes: identifying a second leak along the pipe; attaching a second pipe enclosure to the pipe and the first pipe enclosure, the second pipe enclosure including: a second body having a second void surrounding the pipe; a second male interlocking portion at a first end of the second body, the second male interlocking portion and the second body being integrally formed of a second metal, the second male interlocking portion having a third bore extending therethrough, the third bore being contiguous with the second void; and a second female interlocking portion at a second end of the second body, the second female interlocking portion and the second body being integrally formed of the second metal, the second female interlocking portion having a fourth bore extending therethrough, the fourth bore being contiguous with the second void, the second female interlocking portion and the second male interlocking portion having complimentary shapes; and injecting a second sealant into the second void of the second pipe enclosure.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A, 1B, and 1C illustrate a male-female pipe enclosure, in accordance with some embodiments;

FIG. 2 illustrates a male-male pipe enclosure, in accordance with some embodiments;

FIG. 3 illustrates mating of male-female and male-male pipe enclosures, in accordance with some embodiments;

FIGS. 4A and 4B illustrate installation of pipe enclosures around a pipe, in accordance with some embodiments;

FIG. 5 illustrates a method for sealing leaks in a pipe, in accordance with some embodiments; and

FIG. 6 illustrates a stub pipe enclosure, in accordance with some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

In accordance with some embodiments, a pipe enclosure has interlocking portions at each end of the pipe enclosure. The pipe enclosure may have a female and a male interlocking portion, or two male interlocking portions. Female portions of an interlock may be formed over male portions of an interlock. An initial pipe enclosure installed on a leaking pipe may have two male interlocking portions. Subsequently installed pipe enclosure may have one male and one female interlocking portion. As such, additional pipe enclosures may be connected to the initial pipe enclosure without removing or tampering with the initial pipe enclosure.

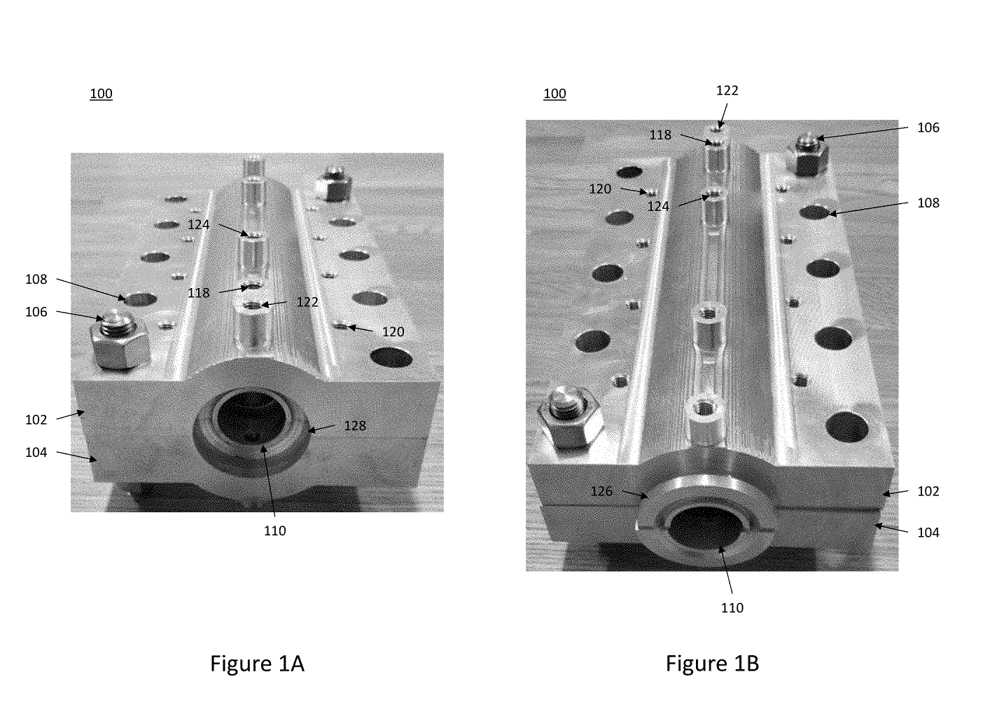

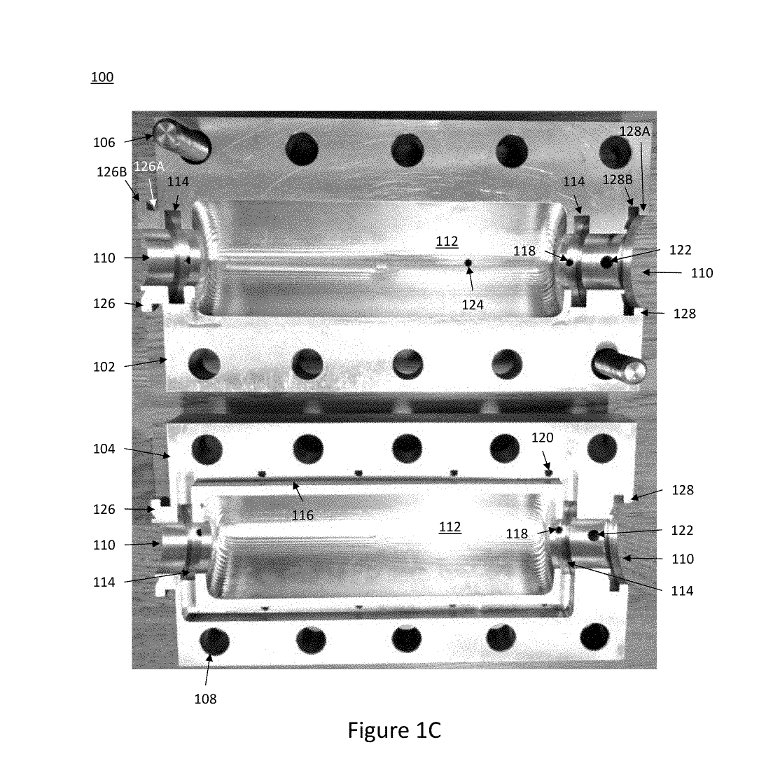

FIGS. 1A, 1B, and 1C illustrate a pipe enclosure 100, in accordance with some embodiments. The pipe enclosure 100 includes a top half 102 (or more generally, a first half) and a bottom half 104 (or more generally, a second half), which are disposed around a pipe during installation (discussed further below). Bolts 106 are secured through clamping holes 108 to mate the top half 102 and bottom half 104, thereby forming the pipe enclosure 100. The clamping holes 108 are aligned when the top half 102 is mated to the bottom half 104. FIG. 1A shows a first (e.g., female interlocking) end of the assembled pipe enclosure 100, FIG. 1B shows a second (e.g., male interlocking) end of the assembled pipe enclosure 100, and FIG. 1C shows the top half 102 and bottom half 104. The top half 102 and bottom half 104 may each be formed from a continuous material such as a metal. In other words, the components of the top half 102 are integrally formed from a first workpiece of the metal, and the components of the bottom half 104 are integrally formed from a second workpiece of the metal. As an example of forming the top half 102 and bottom half 104, a metal piece of, e.g., steel, may be machined using a computer numerical control (CNC) mill.

The top half 102 and bottom half 104 each include a bore portion no and void portion 112. The top half 102 and bottom half 104 together form a body of the pipe enclosure 100. After mating, the bore portions no form a bore, which retains and supports the pipe. Further, after mating, the void portion 112 form a void, which is used to cover the leaking section of the pipe. The bore and void may both be round.

The top half 102 includes bore grooves 114, and the bottom half 104 includes bore grooves 114 and periphery grooves 116. The bore grooves 114 are disposed around the bore portions no of the top half 102 and bottom half 104. The periphery grooves 116 are disposed around the periphery of the bottom half 104. Before mating, packing rope is disposed in the grooves 114 and 116. After mating, sealant is injected into the grooves 114 and 116, which expands around the packing rope. Portions of the sealant and packing rope in the bore grooves 114 seal the bore. Portions of the sealant and packing rope in the periphery grooves 116 seal the void. The sealant is injected into the bore grooves 114 through injection valves 118, and is injected into the periphery grooves 116 through injection valves 120. Some sealant may also be inject directly into the bore through injection valves 122, to provide additional sealing of the bore portions no. In some embodiments, both halves (e.g., the top half 102 and bottom half 104) include the bore grooves 114. In some embodiments, only one half (e.g., the bottom half 104) includes a periphery groove 116. For example, the single periphery groove 116 may be formed in mating surfaces of the bottom half 104, and the single periphery groove 116 mates to corresponding mating surfaces of the top half 102.

Further, after mating, sealant is injected into the void through injection valves 124. The injected sealant expands to fill the void and surround the leaking section of the pipe. The leak may thus be stopped. The sealant in the bore grooves 114 and periphery grooves 116 may be the same as the sealant in the void, or may be a different sealant.

Although a pipe may be repaired, additional leaks may subsequently form in the pipe. For example, a second leak may form that is proximate the first leak. A new pipe enclosure 100 may be used to repair the second leak. When multiple pipe enclosures 100 are attached to a same pipe, they may be connected to provide mechanical stability. In particular, each pipe enclosure 100 includes an interlocking portion at each end of the pipe enclosure 100. The interlocking portions of each pipe enclosure 100 allow multiple pipe enclosures 100 to be securely connected in series. A male interlocking portion 126 is at the first end of each pipe enclosure 100, and a female interlocking portion 128 is at the second end of each pipe enclosure 100. The male interlocking portion 126 and female interlocking portion 128 have complimentary shapes. Because the pipe enclosure 100 has one male end and one female end, it may be referred to as a male-female pipe enclosure. In some embodiments, the male interlocking portion 126 has a neck 126A extending from the body of the pipe enclosure 100, and a lip 126B connected to the neck 126A. The lip 126B is wider than the neck 126A, e.g., a diameter of the lip 126B is greater than a diameter of the neck 126A. In some embodiments, the female interlocking portion 128 has a corresponding neck groove 128A and lip groove 128B in the body of the pipe enclosure 100, where the neck groove 128A is contiguous with the lip groove 128B. The lip groove 128B of the female interlocking portion 128 has the same diameter as the lip 126B of the male interlocking portion 126, and the neck groove 128A of the female interlocking portion 128 has the same diameter as the neck 126A of the male interlocking portion 126.

After repairing a leak, the pipe enclosure 100 remains around the pipe, as removal of the pipe enclosure 100 would result in the leak resuming. As such, when a new pipe enclosure 100 is connected to an existing pipe enclosure 100, the female interlocking portion 128 of the new pipe enclosure 100 is installed over the male interlocking portion 126 of the existing pipe enclosure 100. Advantageously, this allows the new pipe enclosure 100 to be connected without removing or tampering with the existing pipe enclosure 100.

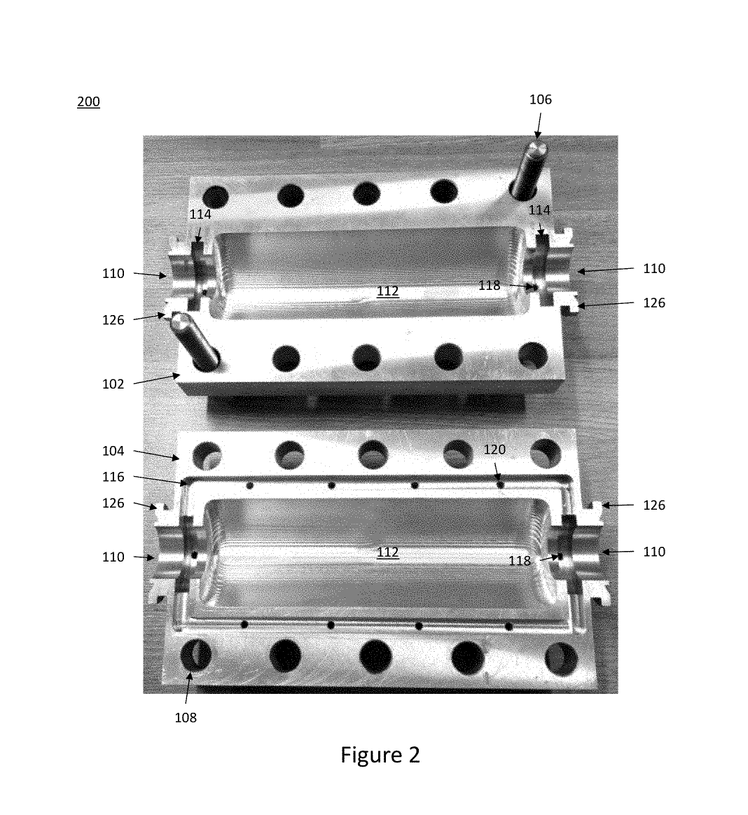

FIG. 2 illustrates a pipe enclosure 200, in accordance with some embodiments. The pipe enclosure 200 is similar to the pipe enclosure 100, except that the pipe enclosure 200 includes a male interlocking portion 126 at both ends of the pipe enclosure 200. Because the pipe enclosure 200 has two male ends, it may be referred to as a male-male pipe enclosure. In some embodiments, both of the male interlocking portions 126 of the pipe enclosure 200 have a same height, a same neck diameter, and a same lip diameter.

A male-male pipe enclosure is the first pipe enclosure installed on a leaking pipe. If other leaks are subsequently formed, male-female pipe enclosures may be connected to the male-male pipe enclosure. Notable, because female interlocking portions 128 may be installed over male interlocking portions 126, a male-female pipe enclosure may be connected to each end of a male-male pipe enclosure without removing or tampering with the male-male pipe enclosure. This allows the series of connected enclosures to grow along the pipe in either direction.

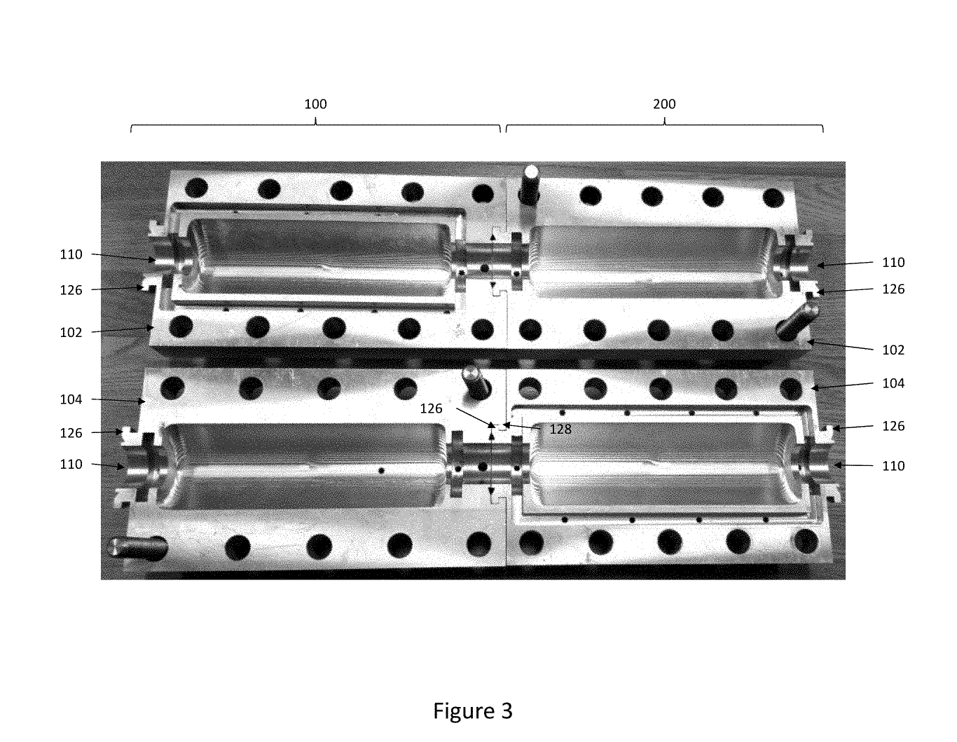

FIG. 3 illustrates mating of a male-female pipe enclosure 100 and a male-male pipe enclosure 200. As illustrated, the female interlocking portion 128 of each pipe enclosure is installed over the male interlocking portion 126 of a corresponding adjacent pipe enclosure.

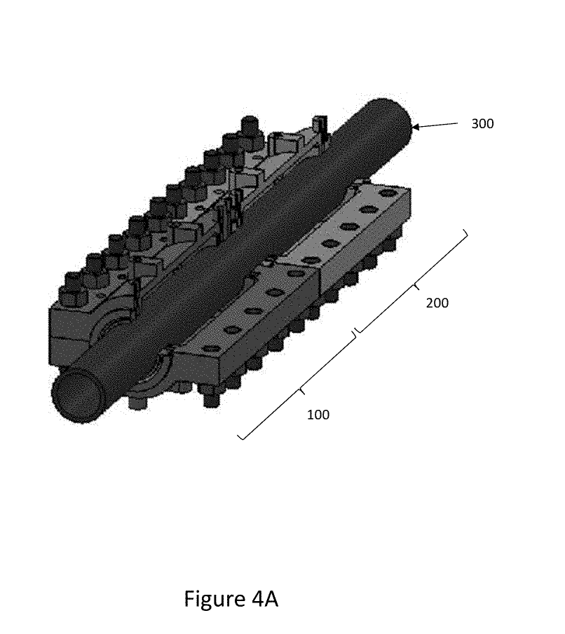

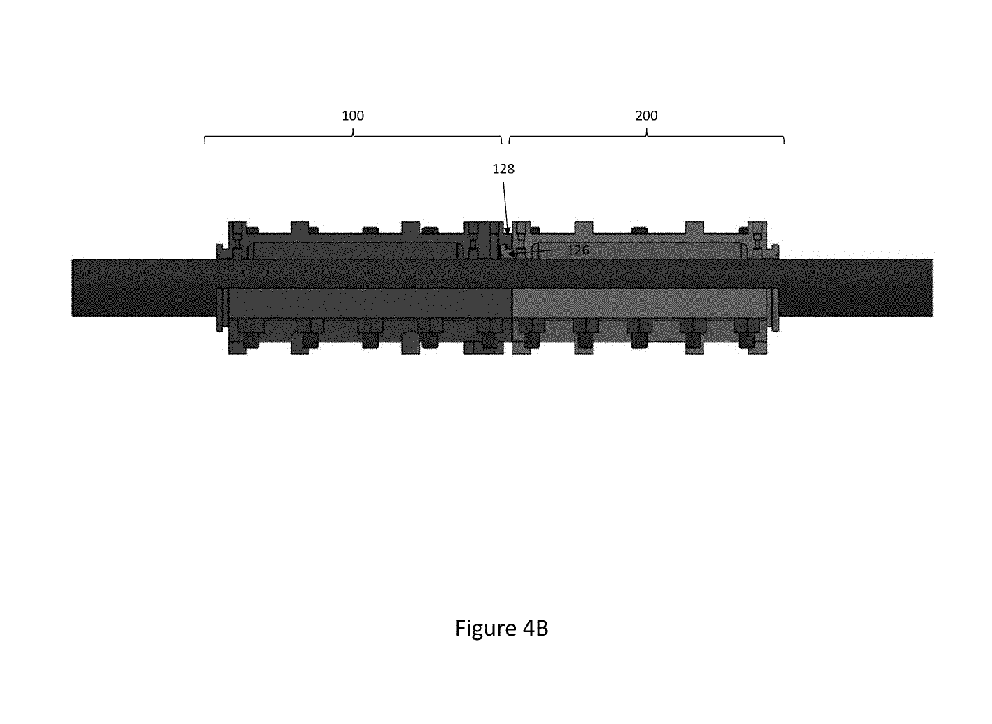

FIGS. 4A and 4B illustrate installation of the pipe enclosures 100 and 200 around a pipe 300, in accordance with some embodiments. After assembly, the pipe 300 extends through the pipe enclosures 100 and 200. The bore portions no of each enclosure half are secured around the pipe 300, and the void portions 112 of each enclosure half encase a leak. Sealant is formed around the bores and in the void, thereby sealing and stopping the leak.

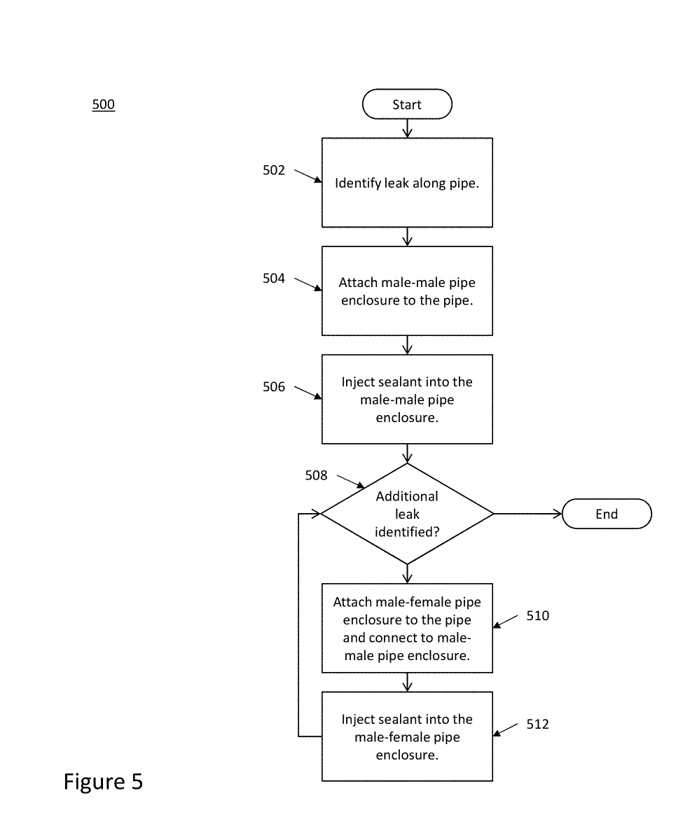

FIG. 5 illustrates a method 500 for sealing leaks in a pipe, in accordance with some embodiments. A leak is identified along the pipe 300 (step 502). A male-male pipe enclosure is attached to the pipe 300 (step 504). Sealant is injected into the male-male pipe enclosure, thereby sealing the leak (step 506). If an additional leak is identified along the pipe 300 (step 508), then a male-female pipe enclosure is attached to the pipe 300 (step 510). The male-female pipe enclosure is attached such that it is connected in series with the male-male pipe enclosure. Sealant is injected into the male-female pipe enclosure, thereby sealing the additional leak (step 512). Steps 508-512 may be repeated until no more leaks are identified.

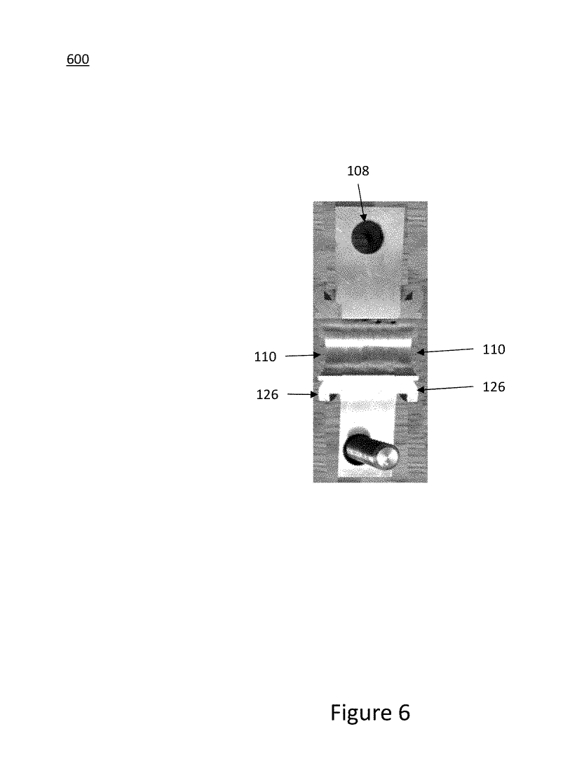

Because each series of pipe enclosures includes one male-male pipe enclosure and multiple male-female pipe enclosures, a pipeline operator may have fewer male-male pipe enclosures on hand at a given time. Sometimes, a repair may need to be performed when no male-male pipe enclosures are available. In accordance with some embodiments, a stub pipe enclosure 600 (shown in FIG. 6) may be provided and used. The stub pipe enclosure 600 is a male-male pipe enclosure that is shorter and does not include the void portions 112 or the grooves 114 and 116. The stub pipe enclosure 600 is not itself used for repairing a leaking pipe, but rather may be fastened around a leaking pipe such that a male-female pipe enclosure may be used to repair the first leak of a pipe. The male-female pipe enclosure may be attached to the stub pipe enclosure 600, and the series of connected pipe enclosures may grow from the original stub and male-female pipe enclosures.

Embodiments may achieve advantages. By first installing a male-male pipe enclosure, male-female pipe enclosures may be subsequently installed without removing or tampering with the male-male pipe enclosure. Subsequent leaks in a pipe may thus be repaired, and the chances of restarting a previously repaired leak may be reduced.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A pipe enclosure comprising:
a body having a void;
a male interlocking portion at a first end of the body, the male interlocking portion and the body being integrally formed of a metal, the male interlocking portion having a first bore extending therethrough, the first bore being contiguous with the void;
a female interlocking portion at a second end of the body, the female interlocking portion and the body being integrally formed of the metal, the female interlocking portion having a second bore extending therethrough, the second bore being contiguous with the void, the female interlocking portion and the male interlocking portion having complimentary shapes;
a first bore groove in the body, the first bore groove being disposed around the first bore;
a second bore groove in the body, the second bore groove being disposed around the second bore; and
a periphery groove in the body, the periphery groove being disposed around the periphery of the void, the periphery groove being contiguous with the first bore groove and the second bore groove.

2. The pipe enclosure of claim 1 further comprising:
an injection valve extending through the body, the injection valve being contiguous with the void.

3. The pipe enclosure of claim 1 further comprising:
an injection valve extending through the body, the injection valve being contiguous with the first bore.

4. The pipe enclosure of claim 1 further comprising:
a first injection valve extending through the body, the first injection valve being contiguous with the first bore groove;
a second injection valve extending through the body, the second injection valve being contiguous with the second bore groove; and
a third injection valve extending through the body, the third injection valve being contiguous with the periphery groove.

5. The pipe enclosure of claim 1, wherein the body comprises:
a first half having a first clamping hole extending therethrough; and
a second half having a second clamping hole extending therethrough,
wherein the first clamping hole and the second clamping hole are aligned when the first half is mated to the second half.

6. The pipe enclosure of claim 5, wherein the first bore groove is formed in the first half and the second half of the body, and the second bore groove is formed in the first half and the second half of the body.

7. The pipe enclosure of claim 5, wherein the periphery groove is formed in mating surfaces of the first half of the body, and the periphery groove mates to corresponding mating surfaces of the second half of the body.

8. The pipe enclosure of claim 1, wherein the male interlocking portion comprises:
a neck extending from the first end of the body, the neck having a first diameter; and
a lip connected to the neck, the lip having a second diameter, the second diameter being greater than the first diameter.

9. The pipe enclosure of claim 8, wherein the female interlocking portion comprises:
a lip groove in a second end of the body, the lip groove having the second diameter; and
a neck groove being contiguous with the lip groove, the neck groove having the first diameter.

10. The pipe enclosure of claim 9, wherein the neck is disposed between the lip and the first bore groove, and the lip groove is disposed between the neck groove and the second bore groove.

11. A system comprising:
a pipe;
a first pipe enclosure around the pipe, the first pipe enclosure comprising:
a first body having a first void surrounding the pipe;
a first male interlocking portion at a first end of the first body, the first male interlocking portion and the first body being integrally formed of a first metal, the first male interlocking portion having a first bore extending therethrough, the first bore being contiguous with the first void; and
a first female interlocking portion at a second end of the first body, the first female interlocking portion and the first body being integrally formed of the first metal, the first female interlocking portion having a second bore extending therethrough, the second bore being contiguous with the first void, the first female interlocking portion and the first male interlocking portion having complimentary shapes; and
a second pipe enclosure around the pipe, the second pipe enclosure comprising:
a second body having a second void surrounding the pipe;
a second male interlocking portion at a first end of the second body, the second male interlocking portion and the second body being integrally formed of a second metal, the second male interlocking portion having a third bore extending therethrough, the third bore being contiguous with the second void; and
a second female interlocking portion at a second end of the second body, the second female interlocking portion and the second body being integrally formed of the second metal, the second female interlocking portion having a fourth bore extending therethrough, the fourth bore being contiguous with the second void, the second female interlocking portion and the second male interlocking portion having complimentary shapes,
wherein the first male interlocking portion of the first pipe enclosure is connected to the second female interlocking portion of the second pipe enclosure.

12. The system of claim 11, wherein the first void and the second void are filled with a sealant.

13. The system of claim 11, wherein the first male interlocking portion comprises:
a neck extending from the first end of the first body, the neck having a first diameter; and
a lip connected to the neck, the lip having a second diameter, the second diameter being greater than the first diameter.

14. The system of claim 13, wherein the second female interlocking portion comprises:
a lip groove in second end of the second body, the lip groove having the second diameter; and
a neck groove being contiguous with the lip groove, the neck groove having the first diameter.

15. A method comprising:
identifying a first leak along a pipe;
attaching a first pipe enclosure to the pipe, the first pipe enclosure comprising:
a first body having a first void;
a first male interlocking portion at a first end of the first body, the first male interlocking portion and the first body being integrally formed of a first metal, the first male interlocking portion having a first bore extending therethrough, the first bore being contiguous with the first void; and
a first female interlocking portion at a second end of the first body, the first female interlocking portion and the first body being integrally formed of the first metal, the first female interlocking portion having a second bore extending therethrough, the second bore being contiguous with the first void, the first female interlocking portion and the first male interlocking portion having complimentary shapes; and
injecting a first sealant into the first void of the first pipe enclosure.

16. The method of claim 15 further comprising:
identifying a second leak along the pipe;
attaching a second pipe enclosure to the pipe and the first pipe enclosure, the second pipe enclosure comprising:
a second body having a second void surrounding the pipe;
a second male interlocking portion at a first end of the second body, the second male interlocking portion and the second body being integrally formed of a second metal, the second male interlocking portion having a third bore extending therethrough, the third bore being contiguous with the second void; and
a second female interlocking portion at a second end of the second body, the second female interlocking portion and the second body being integrally formed of the second metal, the second female interlocking portion having a fourth bore extending therethrough, the fourth bore being contiguous with the second void, the second female interlocking portion and the second male interlocking portion having complimentary shapes; and
injecting a second sealant into the second void of the second pipe enclosure.
